(19) United States
(12) Patent Application Publication
(10) Pub. No.: US 2026/0326440 A1
(43) Pub. Date: Oct. 22, 2026

(54) ACTUATOR UNIT, LIQUID DISCHARGE HEAD, LIQUID DISCHARGE UNIT, IMAGE FORMING APPARATUS, AND LIQUID DISCHARGE APPARATUS

(71) Applicant: Takahiro YOSHIDA, Kanagawa (JP)

(72) Inventor: Takahiro YOSHIDA, Kanagawa (JP)

(21) Appl. No.: 19/463,079

(22) Filed: Jan. 29, 2026

(30) Foreign Application Priority Data
Feb. 18, 2025 (JP) 2025-024414

(51) Int. Cl. B41J 2/15; B41J 2/14; B41J 3/54; B41J 25/00

(52) U.S. Cl. CPC B41J 2/15; B41J 2/1433; B41J 3/543; B41J 25/005

(57) ABSTRACT

An actuator unit includes a nozzle plate having: a first row having multiple nozzles arrayed at a first interval in a first direction; and a second row adjacent to the first row in an inclined direction inclined with respect to a second direction orthogonal to the first direction. The second row has the multiple nozzles arrayed at the first interval in the first direction. The first row and the second row are separated at a second interval in the second direction. The first row of the multiple nozzles has: a first nozzle at one end of the first row; and a second nozzle adjacent to and inward from the first nozzle in the first direction. The second row of the multiple nozzles has: a third nozzle at one end of the second row. The third nozzle is positioned inward from the second nozzle in the first direction.

### CROSS-REFERENCE TO RELATED APPLICATION

This patent application is based on and claims priority pursuant to 35 U.S.C. § 119(a) to Japanese Patent Application No. 2025-024414, filed on Feb. 18, 2025, in the Japan Patent Office, the entire disclosure of each is hereby incorporated by reference herein.

### BACKGROUND

### Technical Field

The present disclosure relates to an actuator unit, a liquid discharge head, a liquid discharge unit, an image forming apparatus, and a liquid discharge apparatus.

### Related Art

A liquid discharge head employed in an inkjet image forming apparatus is known in the art. The liquid discharge head includes an actuator unit to discharge ink as a liquid.

### SUMMARY

The present disclosure described herein provides an improved actuator unit including a nozzle plate having: a first row having multiple nozzles arrayed at a first interval in a first direction; and a second row adjacent to the first row in an inclined direction inclined with respect to a second direction orthogonal to the first direction. The second row has the multiple nozzles arrayed at the first interval in the first direction. The first row and the second row are separated at a second interval in the second direction. The first row of the multiple nozzles has: a first nozzle at one end of the first row in the first direction; and a second nozzle adjacent to and inward from the first nozzle in the first direction. The second row of the multiple nozzles has: a third nozzle at one end of the second row in the first direction, and the third nozzle is positioned inward from the second nozzle in the first direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a nozzle area of an actuator unit according to a comparative example;

FIG. 2 is a schematic diagram illustrating two actuator units arranged side by side according to the comparative example of FIG. 1;

FIG. 3 is a schematic diagram illustrating a nozzle arrangement when actuator units according to the comparative example of FIG. 1 are joined (coupled) to each other;

FIG. 4 is a schematic cross-sectional view of a liquid discharge head;

FIG. 5 is a schematic diagram of actuator units joined (coupled) to each other according to a first embodiment of the present disclosure;

FIG. 6 is a schematic diagram of actuator units joined (coupled) to each other according to a second embodiment of the present disclosure;

FIG. 7 is a schematic diagram of actuator units joined (coupled) to each other according to a third embodiment of the present disclosure;

FIG. 8 is a schematic diagram illustrating multiple actuator units joined (coupled) to each other according to the first to third embodiments of the present disclosure;

FIG. 9 is a schematic diagram illustrating multiple actuator units joined (coupled) to each other according to the comparative example of FIG. 1;

FIG. 10 is a schematic diagram illustrating multiple actuator units joined (coupled) to each other according to a fourth embodiment of the present disclosure;

FIG. 11 is a schematic diagram illustrating specific nozzle positions of the actuator unit of FIG. 10, according to the fourth embodiment of the present disclosure;

FIG. 12 is a schematic diagram illustrating specific nozzle positions of the actuator unit of FIG. 5, according to the first embodiment of the present disclosure;

FIG. 13 is a schematic front view of a liquid discharge apparatus including a liquid discharge head;

FIG. 14 is a schematic plan view of a liquid discharge unit of the liquid discharge apparatus of FIG. 13 including the liquid discharge head;

FIG. 15 is a schematic plan view of a liquid discharge apparatus including a liquid discharge head;

FIG. 16 is a schematic side view of the liquid discharge apparatus of FIG. 15 including the liquid discharge head;

FIG. 17 is a schematic plan view of a liquid discharge unit of a liquid discharge apparatus including a liquid discharge head;

FIG. 18 is a schematic front view of another liquid discharge unit of a liquid discharge apparatus including a liquid discharge head; and

FIG. 19 is a schematic front view of an electrode manufacturing apparatus as a liquid discharge apparatus including a liquid discharge head.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

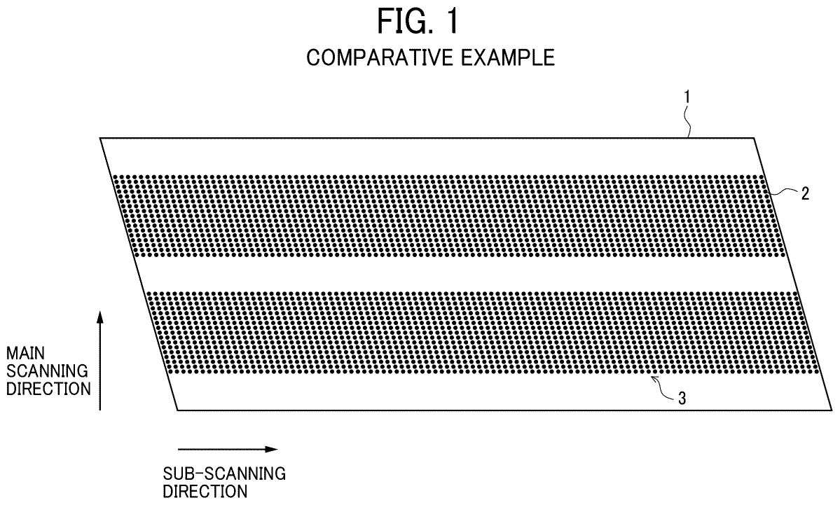

In a comparative example, a liquid discharge head is employed in an inkjet image forming apparatus. The liquid discharge head includes an actuator unit to discharge ink as a liquid. In the configuration illustrated in FIG. 1, for example, an actuator unit 1 has a parallelogram shape. The actuator unit 1 has a nozzle area 3 in which multiple nozzles 2, which are liquid discharge ports, are arrayed in a matrix. In the nozzle area 3, in addition to the nozzles 2, pressure chambers and piezoelectric elements corresponding to the nozzles 2 are arranged.

In the actuator unit 1, the nozzles 2 are arrayed in the direction inclined at an angle with respect to the main scanning direction. In other words, the nozzles 2 in one row are disposed adjacent to the nozzles in another row in an inclined direction inclined with respect to the main scanning direction. One of the nozzles 2 in the main scanning direction is located at a position complementing the other of the nozzles 2 in the main scanning direction. Multiple actuator units 1 can be arranged in the sub-scanning direction, which is a conveyance direction of a recording medium. The multiple actuator units 1 are bonded to each other, for example, to support the entire width of the recording medium.

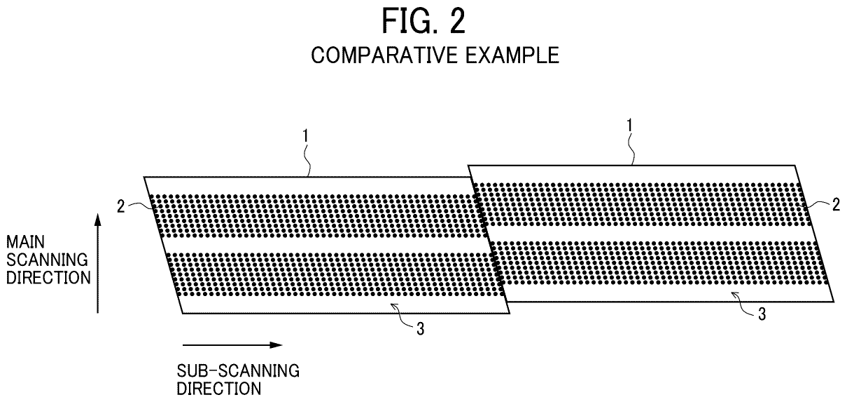

In the structure of the multiple actuator units 1 bonded to each other, as illustrated in FIG. 2, the nozzles 2 and components corresponding to the nozzles 2, such as the pressure chambers and the piezoelectric elements, are arranged in the vicinity of the ends of the bonding portions of the respective actuator units 1. For this reason, the components, such as the nozzles 2 or the pressure chambers, may be exposed at the ends of the bonding portions of the actuator units 1. Accordingly, the actuator units 1 are likely to be damaged by an external factor such as an impact received at the ends. As a result, the pressure chambers may be damaged or ink may leak from the pressure chambers, and thus the robustness of the actuator units 1 is low and the liquid discharge head may be broken. Further, only a predetermined number of actuator units 1 is arranged, and it is difficult to manufacture an inkjet head having a desired length.

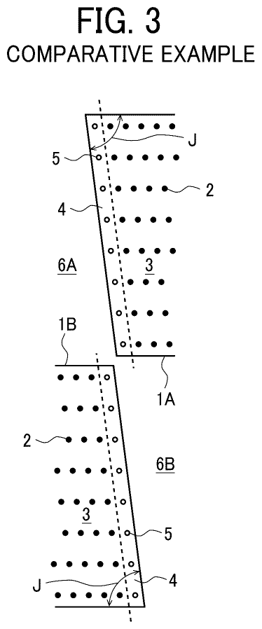

FIG. 3 illustrates the arrangement of nozzles in an actuator unit according to a comparative example. As described above, the nozzles 2 are arrayed at the end of the actuator unit 1, but an ink channel is not formed at the end of the actuator unit 1, resulting in poor robustness. For this reason, in the configuration illustrated in FIG. 3, a margin 4 for one column of nozzles is formed at the end of the actuator unit 1. In the margin 4, nozzles are not formed at nozzle formation positions indicated by white circles 5 where the nozzles 2 can be originally formed in accordance with intervals of the nozzles 2. In FIG. 3, an actuator unit 1A is positioned on the right side, and an actuator unit 1B is positioned on the left side. Each of the actuator unit 1A and the actuator unit 1B has eight rows of the nozzles 2 arrayed in the vertical direction in FIG. 3, and the nozzles 2 are arrayed in the lateral direction in FIG. 3 in each row.

When the actuator unit 1A and the actuator unit 1B having the above-described configuration are bonded to each other, even if the margins 4 of the actuator units 1A and 1B are joined, the nozzles 2 are not formed in the margins 4. Accordingly, to array the nozzles 2 so that one of the nozzles 2 in the main scanning direction is located at a position complementing the other of the nozzles 2 in the main scanning direction, the actuator units 1A and 1B are arranged so as to be shifted vertically as illustrated in FIG. 3. When multiple actuator units 1 are arranged, the size of the actuator units 1 in the main scanning direction may increase.

Further, a non-discharge area 6A where ink is not discharged is formed on the left side of the actuator unit 1A, and a similar non-discharge area 6B is formed on the right side of the actuator unit 1B. Accordingly, the nozzles 2 in the actuator units 1A and 1B become asymmetrical, and the nozzles 2 at the ends are affected by airflow, causing discharge bending of the ink discharged from the nozzles 2.

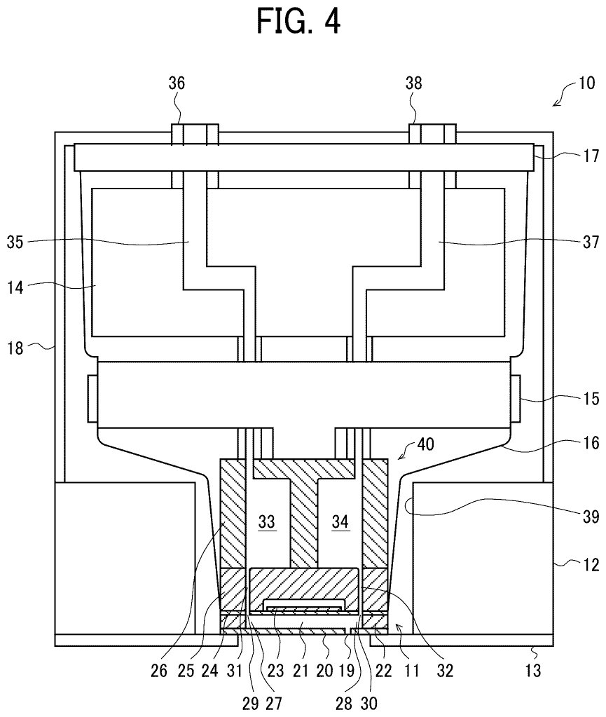

FIG. 4 is a schematic cross-sectional view of a liquid discharge unit 10 in a transverse direction of a liquid discharge head. In FIG. 4, the liquid discharge unit 10 includes multiple liquid discharge heads 11 that discharge a liquid, a base 12 that holds the multiple liquid discharge heads 11, and a cover 13 serving as a nozzle cover that covers the multiple liquid discharge heads 11. The liquid discharge unit 10 further includes a manifold 14 defining channels to supply the liquid to the multiple liquid discharge heads 11, a printed circuit board (PCB) 17 connected to a flexible wiring 16 including a driver integrated circuit (IC) 15, and a module case 18.

Each of the multiple liquid discharge heads 11 includes a nozzle substrate 20 (i.e., a nozzle plate), a channel substrate 22, a diaphragm 24, a piezoelectric element holding substrate 25, and a frame 26 as a common channel substrate. Nozzles 19 are formed in the nozzle substrate 20. The channel substrate 22 defines individual chambers 21 serving as pressure chambers communicating with the nozzles 19, respectively. The diaphragm 24 includes piezoelectric elements 23. The piezoelectric element holding substrate 25 is laminated over the diaphragm 24. The frame 26 is laminated over the piezoelectric element holding substrate 25.

A material for the nozzle substrate 20 is a single-crystal silicon wafer. In addition to the individual chambers 21, the channel substrate 22 defines supply-side individual channels 27 communicating with the individual chambers 21 and collection-side individual channels 28 communicating with the individual chambers 21, respectively.

A material for the piezoelectric element holding substrate 25 is a single-crystal silicon wafer. The piezoelectric element holding substrate 25 defines supply-side intermediate individual channels 31 and collection-side intermediate individual channels 32. The supply-side intermediate individual channels 31 communicate with the supply-side individual channels 27 via openings 29 of the diaphragm 24. The collection-side intermediate individual channels 32 communicate with the collection-side individual channels 28 via openings 30 of the diaphragm 24.

The piezoelectric element holding substrate 25 and the frame 26 define a supply-side common channel 33 and a collection-side common channel 34. The supply-side common channel 33 communicates with the supply-side intermediate individual channels 31. The collection-side common channel 34 communicates with the collection-side intermediate individual channels 32.

The supply-side common channel 33 communicates with a supply port 36 via a channel 35 of the manifold 14, and the collection-side common channel 34 communicates with a collection port 38 via a channel 37 of the manifold 14. The PCB 17 and the piezoelectric elements 23 are connected to each other via the flexible wiring 16, and the driver IC 15 is mounted on the flexible wiring 16.

In FIG. 4, components hatched with diagonal lines, such as the nozzle substrate 20, the channel substrate 22, the piezoelectric element 23, and an actuator, construct an actuator unit 40.

The multiple liquid discharge heads 11 are mounted on the base 12 at predetermined intervals. The liquid discharge head 11 is inserted into an opening 39 in the base 12, and the peripheral end of the nozzle substrate 20 of the liquid discharge head 11 is bonded and fixed to the cover 13, which is bonded and fixed to the base 12, to attach the liquid discharge head 11 to the base 12.

A flange disposed outside the frame 26 of the liquid discharge head 11 is bonded and fixed to the base 12. A structure for fixing the liquid discharge head 11 to the base 12 is not limited to the above-described structure. The liquid discharge head 11 may be fixed to the base 12 by, for example, bonding, swaging, riveting, or screwing.

A description is given below of the configuration of the actuator unit 40 including the nozzle substrate 20 having the multiple nozzles 19 formed therein, as well as the joining (coupling) of two actuator units 40A and 40B.

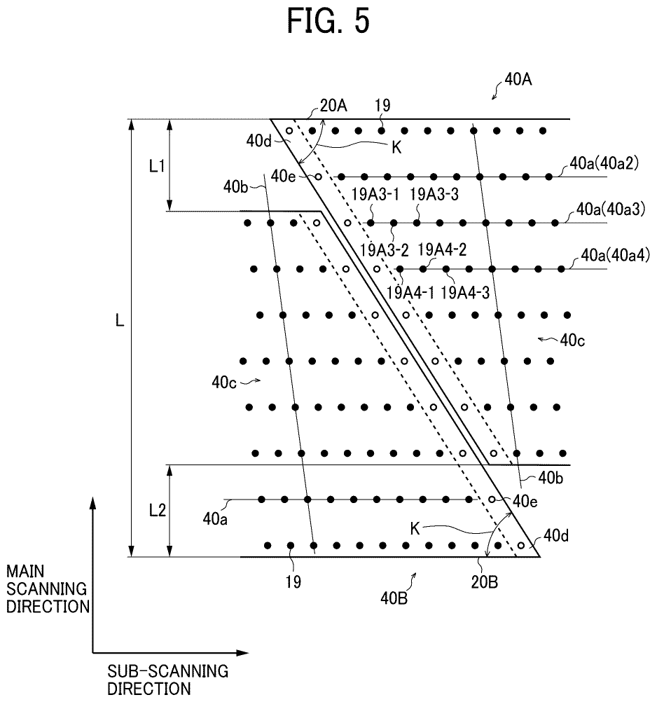

FIG. 5 is a schematic diagram of actuator units joined (coupled) to each other according to a first embodiment of the present disclosure. In FIG. 5, the actuator unit 40A, which has a configuration similar to that of the actuator unit 40, includes a nozzle substrate 20A (i.e., the nozzle plate) on which the multiple nozzles 19 are formed. The actuator unit 40B, which has a configuration similar to that of the actuator unit 40, includes a nozzle substrate 20B (i.e., the nozzle plate) on which the multiple nozzles 19 are formed. The nozzle substrate 20A and the nozzle substrate 20B have the same trapezoidal shape.

For example, each of the nozzle substrates 20A and 20B has a trapezoidal shape having a shorter base extending in the longitudinal direction, a longer base parallel to the shorter base and longer than the shorter base, and legs connecting the shorter base and the longer base. The multiple rows are arranged in an order of the first row and the second row in the transverse direction from the longer base toward the shorter base. The multiple nozzles include end nozzles at ends of the multiple rows arrayed along each of the legs.

On the nozzle substrates 20A and 20B, the multiple nozzles 19 are arrayed at equal intervals (i.e., a first interval) in parallel to the sub-scanning direction, which is a conveyance direction of a recording medium or a longitudinal direction (i.e., a first direction) of the nozzle substrates 20A and 20B, in each of multiple rows 40a (eight rows in FIG. 5), and arrayed at equal intervals (i.e., a second interval) at a predetermined angle with respect to the main scanning direction, which is an image forming direction or a transverse direction (i.e., a second direction) of the nozzle substrates 20A and 20B orthogonal to the longitudinal direction, in each of multiple columns 40b. Thus, the multiple nozzles 19 are arrayed in the multiple rows 40a and the multiple columns 40b to form a nozzle area 40c.

A margin 40d for one column of the nozzles 19 is formed at the ends of the nozzle substrates 20A and 20B because the ink channel is not formed and the robustness is poor at the ends of the nozzle substrates 20A and 20B. In the margin 40d, nozzles are not formed at nozzle formation positions indicated by white circles 40e where the nozzles 19 can be originally formed in accordance with intervals of the nozzles 19.

In the nozzle substrate 20A, for example, a third row 40a3 third from the top in FIG. 5 is referred to as a first row, and a fourth row 40a4 fourth from the top in FIG. 5 is referred to as a second row. The nozzle at the extreme end of the row 40a3 is referred to as a nozzle 19A3-1 (i.e., a first nozzle), and nozzles 19A3-2 (i.e., a second nozzle adjacent to and inward from the first nozzle in the longitudinal direction), 19A3-3, . . . are arrayed downstream in the sub-scanning direction, following the nozzle 19A3-1. The nozzle at the extreme end of the row 40a4 is referred to as a nozzle 19A4-1 (i.e., a third nozzle), and nozzles 19A4-2, 19A4-3, . . . are arrayed downstream in the sub-scanning direction, following the nozzle 19A4-1.

The shape of the end of the nozzle substrate 20A is determined so that the nozzle 19A4-1 at the end of the row 40a4, which is referred to as the second row, is positioned downstream from the nozzle 19A3-2 second from the end of the row 40a3, which is referred to as the first row, in the sub-scanning direction. In other words, the shape of the left end of the nozzle substrate 20A is a diagonal line extending from the upper left to the lower right in FIG. 5. The nozzle 19A4-1 (i.e., the third nozzle) is positioned inward from the nozzle 19A3-2 (i.e., the second nozzle) in the longitudinal direction. The diagonal line in FIG. 5 has a gentler slope and is closer to the horizontal than the shape of the left end of the nozzle substrate of the actuator unit 1A illustrated in FIG. 3.

The nozzle substrate 20B of the actuator unit 40B is arranged upside down in FIG. 5 as compared with the nozzle substrate 20A such that the right end of the nozzle substrate 20B is joined (coupled) to the left end of the nozzle substrate 20A. The arrangement of the nozzles 19 in the nozzle substrate 20B is the same as that of the nozzle substrate 20A.

In other words, the multiple actuator units include: a first actuator unit having the shorter base and the longer base; and a second actuator unit coupled to the first actuator unit in the first direction, and the second actuator unit has the shorter base and the longer base arranged opposite to the shorter base and the longer base of the first actuator unit in the second direction.

With this configuration, an angle K at the left end of the nozzle substrate 20A illustrated in FIG. 5 is more acute than an angle J at the left end of the nozzle substrate of the actuator unit 1A illustrated in FIG. 3. This configuration reduces interference between the actuator unit 40A and the actuator unit 40B, and reduces a length L of the actuator unit 40A and the actuator unit 40B, which are joined (coupled) to each other, in the main scanning direction. Further, this configuration reduces the asymmetry of the nozzle arrangement in the actuator unit, i.e., the lengths of regions L1 and L2, and prevents the discharge bending at the end due to a discharge airflow.

Accordingly, an actuator unit can be provided that prevents the increase in size and prevents the discharge bending.

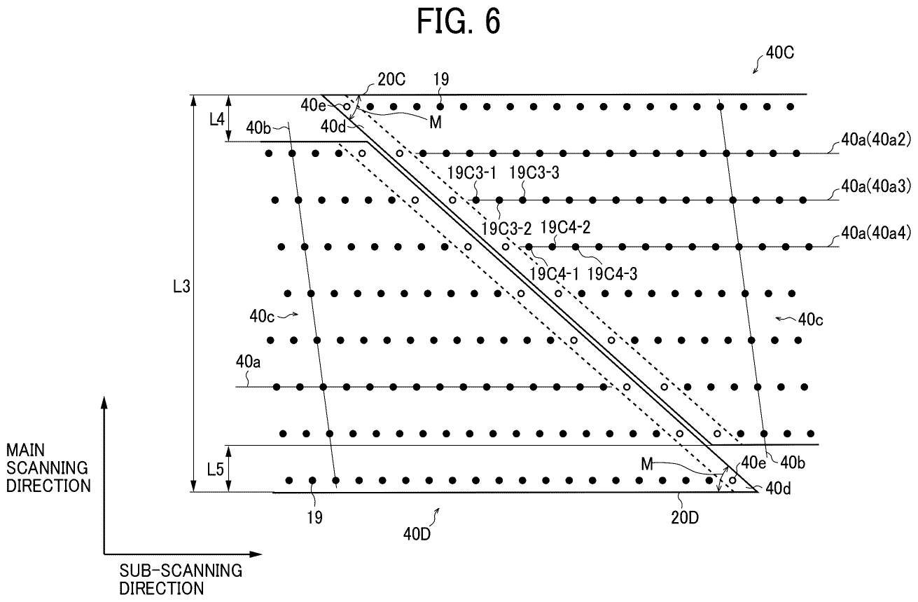

A description is given below of a second embodiment of the present disclosure with reference to FIG. 6. The second embodiment is different from the first embodiment in that actuator units 40C and 40D are used instead of the actuator units 40A and 40B.

In FIG. 6, the actuator unit 40C, which has a configuration similar to that of the actuator unit 40, includes a nozzle substrate 20C (i.e., the nozzle plate) on which the multiple nozzles 19 are formed. The actuator unit 40D, which has a configuration similar to that of the actuator unit 40, includes a nozzle substrate 20D (i.e., the nozzle plate) on which the multiple nozzles 19 are formed. The nozzle substrate 20C and the nozzle substrate 20D have the same trapezoidal shape.

The substrates 20C and 20D have the same nozzle arrangement as the nozzle substrates 20A and 20B, i.e., the nozzles 19 are arrayed at the same positions as those of the nozzle substrates 20A and 20B, in the rows 40a and columns 40b to form the nozzle area 40c.

A margin 40d for one column of the nozzles 19 is formed at the ends of the nozzle substrates 20C and 20D, similarly to the nozzle substrates 20A and 20B. In the margin 40d, nozzles are not formed at nozzle formation positions indicated by white circles 40e where the nozzles 19 can be originally formed in accordance with intervals of the nozzles 19.

In the nozzle substrate 20C, for example, a third row 40a3 third from the top in FIG. 6 is referred to as a first row, and a fourth row 40a4 fourth from the top in FIG. 6 is referred to as a second row. The nozzle at the extreme end of the row 40a3 is referred to as a nozzle 19C3-1, and nozzles 19C3-2, 19C3-3, . . . are arrayed downstream in the sub-scanning direction, following the nozzle 19C3-1. The nozzle at the extreme end of the row 40a4 is referred to as a nozzle 19C4-1, and nozzles 19C4-2, 19C4-3, . . . are arrayed downstream in the sub-scanning direction, following the nozzle 19A4-1.

The shape of the end of the nozzle substrate 20C is determined so that the nozzle 19C4-1 at the end of the row 40a4, which is referred to as the second row, is positioned downstream from the nozzle 19C3-3 third from the end of the row 40a3, which is referred to as the first row, in the sub-scanning direction. In other words, the shape of the left end of the nozzle substrate 20C is a diagonal line extending from the upper left to the lower right in FIG. 6. The nozzle 19C4-1 (i.e., the third nozzle) is positioned inward from the nozzle 19C3-3 (i.e., a fourth nozzle) in the longitudinal direction. The diagonal line in FIG. 6 has a gentler slope and is closer to the horizontal than the shape of the left end of the nozzle substrate 20A described in the first embodiment. The nozzle substrate 20D of the actuator unit 40D is arranged upside down in FIG. 6 as compared with the nozzle substrate 20C such that the right end of the nozzle substrate 20D is joined (coupled) to the left end of the nozzle substrate 20C. The arrangement of the nozzles 19 in the nozzle substrate 20D is the same as that of the nozzle substrate 20C.

With this configuration, an angle M at the left end of the nozzle substrate 20C illustrated in FIG. 6 is more acute than the angle K at the left end of the nozzle substrate 20A. This configuration reduces interference between the actuator unit 40C and the actuator unit 40D, and reduces a length L3 of the actuator unit 40C and the actuator unit 40D, which are joined (coupled) to each other, shorter than the length L in the first embodiment in the main scanning direction. Further, this configuration reduces the asymmetry of the nozzle arrangement in the actuator unit, i.e., the lengths of regions L4 and L5, and prevents the discharge bending at the end due to the discharge airflow.

Accordingly, an actuator unit can be provided that further prevents the increase in size and prevents the discharge bending.

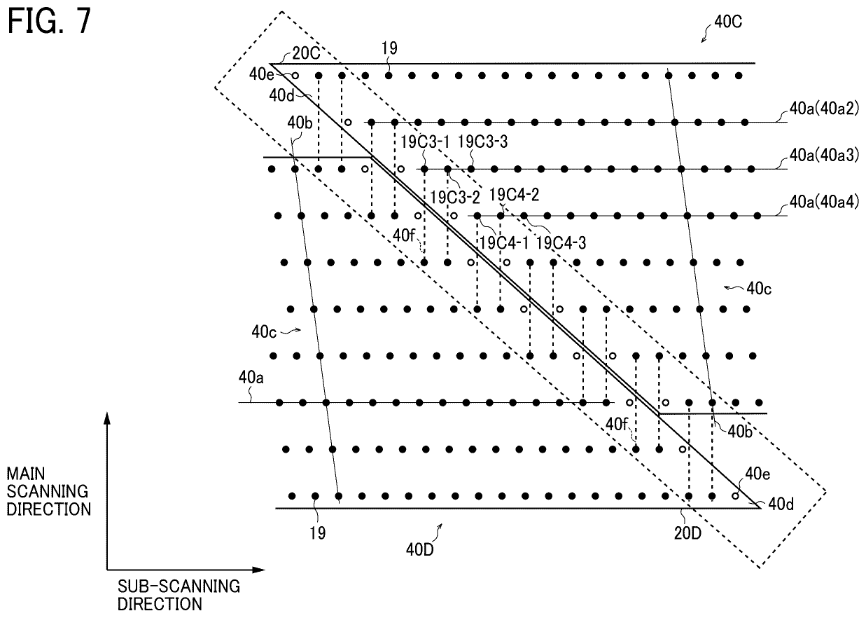

FIG. 7 illustrates a third embodiment of the present disclosure. The third embodiment is different from the second embodiment in that the actuator units 40C and 40D are joined (coupled) to each other with an offset to provide an overlapping portion where the nozzles 19 overlap in the main scanning direction.

As illustrated in FIG. 7, in the bonding portion between the actuator unit 40C and the actuator unit 40D, the nozzles 19 of the actuator unit 40C and the nozzles 19 of the actuator unit 40D are connected to each other by dashed lines to form multiple sets (16 sets in FIG. 7) of overlapping portions 40f. The two nozzles 19 forming each overlapping portion 40f are arranged at positions overlapping each other in a direction parallel to the main scanning direction. In other words, the actuator unit 40C (i.e., a first actuator unit) and the second actuator unit 40D (i.e., a second actuator unit) form an overlapping portion 40f in which the multiple nozzles 19 in a part of the multiple columns of the first actuator unit are overlapped with the multiple nozzles 19 in another part of the multiple columns of the second actuator unit in the transverse direction. In still other words, the first actuator unit is coupled to the second actuator unit. The second actuator unit has the overlapping portion overlapped with the overlapping portion of the first actuator unit, and a nozzle of the first actuator unit in the overlapping portion is disposed at a same position with a nozzle of the second actuator unit in the overlapping portion in the first direction.

Even when the overlapping portion 40f is provided, the length of the actuator unit 40C and the actuator unit 40D joined (coupled) to each other in the main scanning direction can be reduced. Furthermore, although the pitch between the nozzles of the respective actuator unit 40C and actuator unit 40D is narrowed or widened at the bonding portion between the actuator unit 40C and the actuator unit 40D, the overlapping portion can reduce defective images such as streaks or unevenness in an image using image processing at the bonding portion.

Further, this configuration reduces the asymmetry of the nozzle arrangement in the actuator unit and prevents the discharge bending at the end due to the discharge airflow.

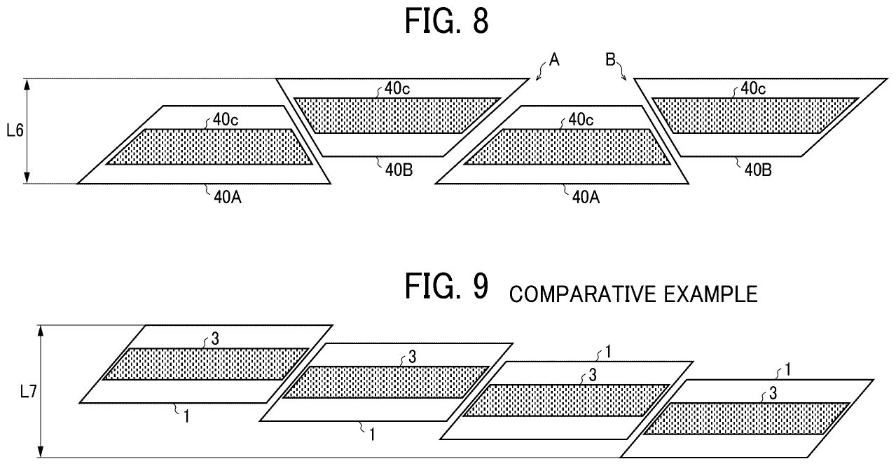

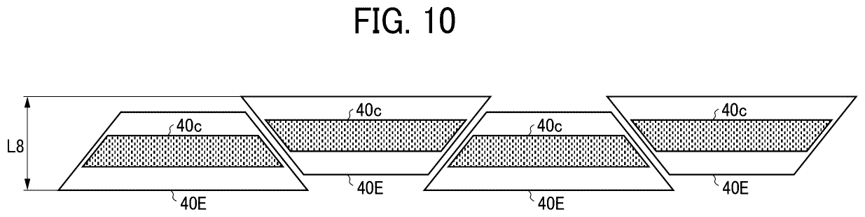

FIG. 8 illustrates actuator units 40 (representatively illustrating actuator units 40A and 40B) with the bottom portion (i.e., the nozzle substrate 20) having a trapezoidal shape. FIG. 9 illustrates actuator units 1 with the bottom portion having a parallelogram shape according to the comparative example.

As illustrated in FIG. 8, when multiple actuator units including the bottom portion having the same size in the vertical direction in the drawings are joined (coupled) to each other, a length L6 can be made shorter than a length L7 in the configuration according to the comparative example to reduce the size of the liquid discharge unit 10.

In the first to third embodiments, the shape of the bottom portion of the actuator units 40A and 40B is bilaterally asymmetrical. For this reason, the length in the vertical direction in FIG. 8 is not reduced at the bonding portion on one side of the bottom base (longer base) of the trapezoidal shape with a corner B having the base angle (interior angle). The base angle of the corner B is larger than that of a corner A on the other side of the bottom base.

Accordingly, although the length in the vertical direction can be reduced in the bonding portion on the other side with the corner A having the smaller base angle, the length in the vertical direction on the one side with the corner B is not reduced in FIG. 8. The length of the actuator units 40A and 40B joined (coupled) together in the vertical direction remains long. A description is given below of a configuration that solves this situation.

FIG. 10 illustrates actuator units 40E according to a fourth embodiment of the present disclosure. The actuator unit 40E is different from the actuator unit 40A, the actuator unit 40B, the actuator unit 40C, and the actuator unit 40D in that the bottom portion has an isosceles trapezoidal shape, which is a bilaterally symmetrical shape, instead of a trapezoidal shape.

The bottom portion having the bilaterally symmetrical shape can reduce the distances in the lateral direction of FIG. 10 in the bonding portion of each actuator unit 40E equally on both left and right sides, and a length L8 in the vertical direction can be made shorter than the length L6 illustrated in the fourth embodiment to further reduce the size of the liquid discharge unit 10.

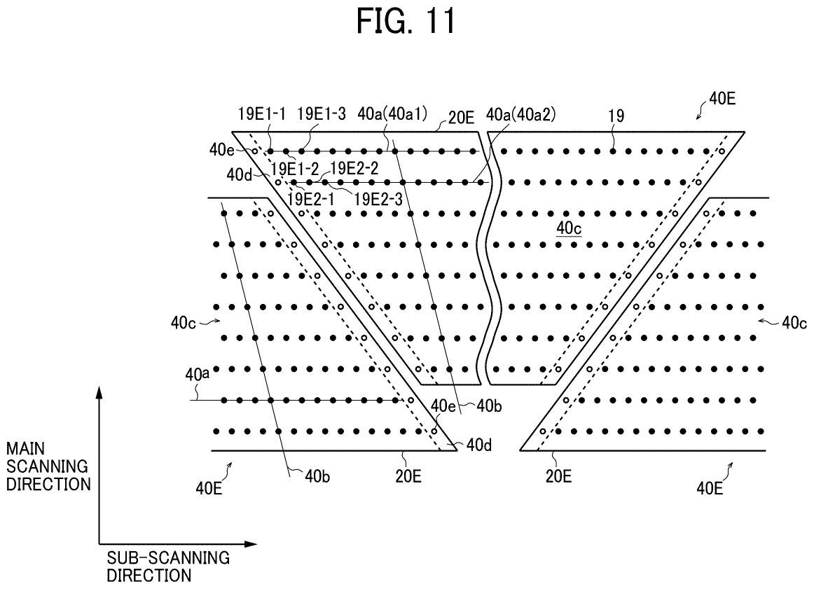

FIG. 11 illustrates specific nozzle positions of the actuator unit 40E. In the fourth embodiment, multiple actuator units 40E, each of which includes a nozzle substrate 20E having an isosceles trapezoid shape, are alternately joined (coupled) upside down to each other.

In the nozzle substrate 20E, the nozzles 19 are arrayed at positions different from those of the nozzle substrates 20A, 20B, 20C, and 20D, in the rows 40a and columns 40b to form the nozzle area 40c. Similarly to the above-described embodiments, the margin 40d is formed at the ends of each nozzle substrate 20E. In the margin 40d, nozzles are not formed at nozzle formation positions indicated by white circles 40e where the nozzles 19 can be originally formed in accordance with intervals of the nozzles 19.

In FIG. 11, in the nozzle substrate 20E of the actuator unit 40E positioned on the upper side of the bonding portion, for example, an uppermost row 40a1 is referred to as the first row, and a second row 40a2 second from the top is referred to as the second row. The nozzle closest to the left end of the row 40a1 is referred to as a nozzle 19E1-1, and nozzles 19E1-2, 19E1-3, . . . are arrayed downstream in the sub-scanning direction, following the nozzle 19E1-1. The nozzle closest to the left end of the row 40a2 is referred to as a nozzle 19E2-1, and nozzles 19E2-2, 19E2-3, . . . are arrayed downstream in the sub-scanning direction, following the nozzle 19E2-1.

The shape of the end of the nozzle substrate 20E is determined so that the nozzle 19E2-1 at the end of the row 40a2, which is referred to as the second row, is positioned downstream from the nozzle 19E1-2 second from the end of the row 40a1, which is referred to as the first row, in the sub-scanning direction. The nozzle 19E2-1 (i.e., the third nozzle) is positioned between the nozzle 19E1-2 (i.e., the second nozzle) and the nozzle 19E1-3 (i.e., the fourth nozzle) third from the end of the row 40a1 which is referred to as the first row.

With this nozzle arrangement, the shapes of both ends of the nozzle substrate 20E in the lateral direction in FIG. 11 can be formed with the same base angle to form the nozzle substrate 20E having an isosceles trapezoidal shape, which is a bilaterally symmetrical shape.

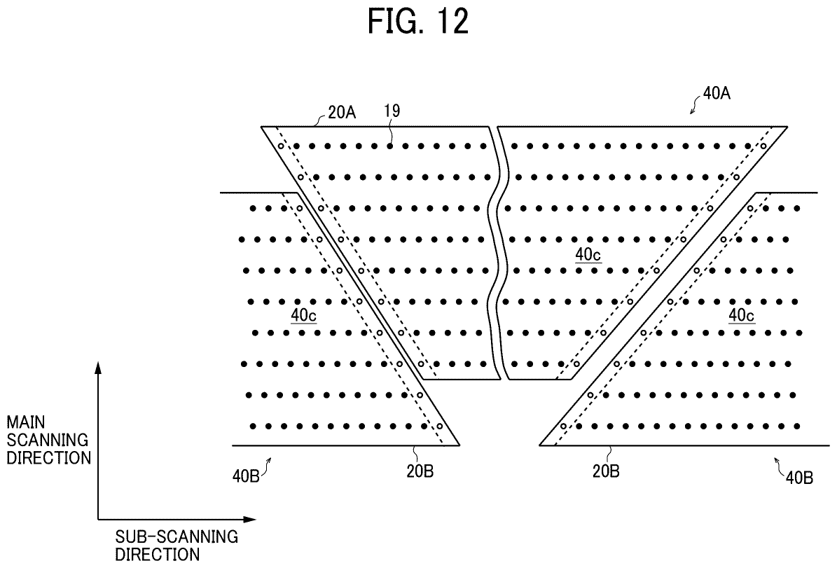

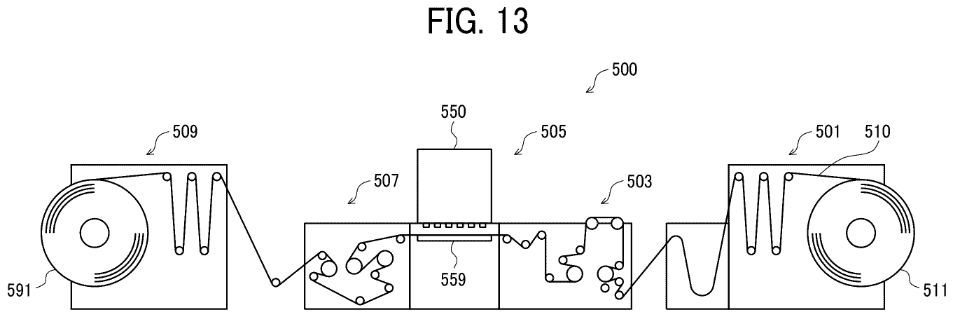

FIG. 12 illustrates the configuration of the coupling of the actuator units 40A and 40B according to the first embodiment. In FIGS. 11 and 12, the third row 40a third from the top of the actuator unit 40A or 40E on the upper side is aligned with the uppermost row 40a of the actuator unit 40B or 40E on the lower side. The configuration of FIG. 12 having a bilaterally asymmetrical shape has a smaller distance between the actuator unit 40A on the upper side and the actuator unit 40B on the lower side than the configuration of FIG. 11 having a bilaterally symmetrical shape. This is because the nozzle substrate 20A of the actuator unit 40A of FIG. 12 has a bilaterally asymmetrical shape, both base angles are different from each other.

The row of the nozzles 19 of the actuator unit on the upper side may not be aligned with the row of the nozzles of the actuator unit on the lower side at the same position in the main scanning direction as illustrated in FIGS. 11 and 12. This is because the liquid discharge timing between the actuator units can be corrected. Accordingly, in the configuration illustrated in FIG. 11, the distance between the actuator units can be wide as compared with the configuration illustrated in FIG. 12, and thus the length in the vertical direction between the actuator units 40E can be reduced.

A description is given below of a liquid discharge apparatus including the liquid discharge head 11 described above.

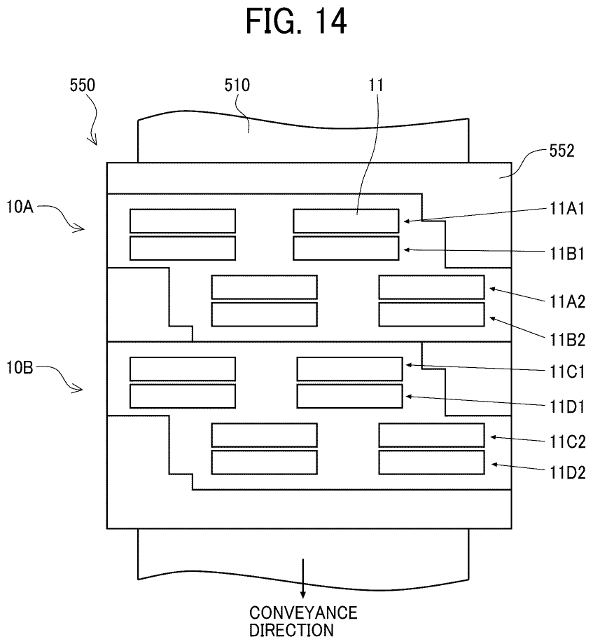

As illustrated in FIGS. 13 and 14, a printer 500 serving as the liquid discharge apparatus includes a feeder 501 to feed a continuous medium 510 as a recording medium, a guide conveyor 503 to guide and convey the continuous medium 510, fed from the feeder 501, to a printing unit 505. The printer 500 further includes the printing unit 505 to discharge a liquid onto the continuous medium 510 to form an image on the continuous medium 510, a dryer 507 to dry the continuous medium 510 to which the liquid adheres, and a carrier 509 to feed the dried continuous medium 510 outward.

The continuous medium 510 is fed from a winding roller 511 of the feeder 501, guided and conveyed with rollers of the feeder 501, the guide conveyor 503, the dryer 507, and the carrier 509, and wound around a take-up roller 591 of the carrier 509. These rollers serve as a conveyor to convey the continuous medium 510.

In the printing unit 505, the continuous medium 510 is conveyed on a conveyance guide 559 so as to face a head unit 550 as a liquid discharge unit. The head unit 550 discharges a liquid onto the continuous medium 510 to print an image.

The printer 500 includes liquid discharge units 10A and 10B, which are similar to the above-described liquid discharge unit 10, in the head unit 550. The liquid discharge units 10A and 10B are mounted on a common base 552.

The liquid discharge unit 10A includes head arrays 11A1, 11B1, 11A2, and 11B2. Each of the head arrays 11A1, 11B1, 11A2, and 11B2 includes liquid discharge heads 11 arranged in a head array direction perpendicular to a conveyance direction of the continuous medium 510. The liquid discharge unit 10B includes head arrays 11C1, 11D1, 11C2, and 11D2. Each of the head arrays 11C1, 11D1, 11C2, and 11D2 includes liquid discharge heads 11 arranged in the head array direction. The head arrays 11A1 and 11A2 of the liquid discharge unit 10A discharge liquid of the same color. Similarly, the head arrays 11B1 and 11B2 of the liquid discharge unit 10A are grouped as one set and discharge liquid of the same desired color. The head arrays 11C1 and 11C2 of the liquid discharge unit 10B are grouped as one set and discharge liquid of the same desired color. The head arrays 11D1 and 11D2 of the liquid discharge unit 10B are grouped as one set and discharge liquid of the same desired color.

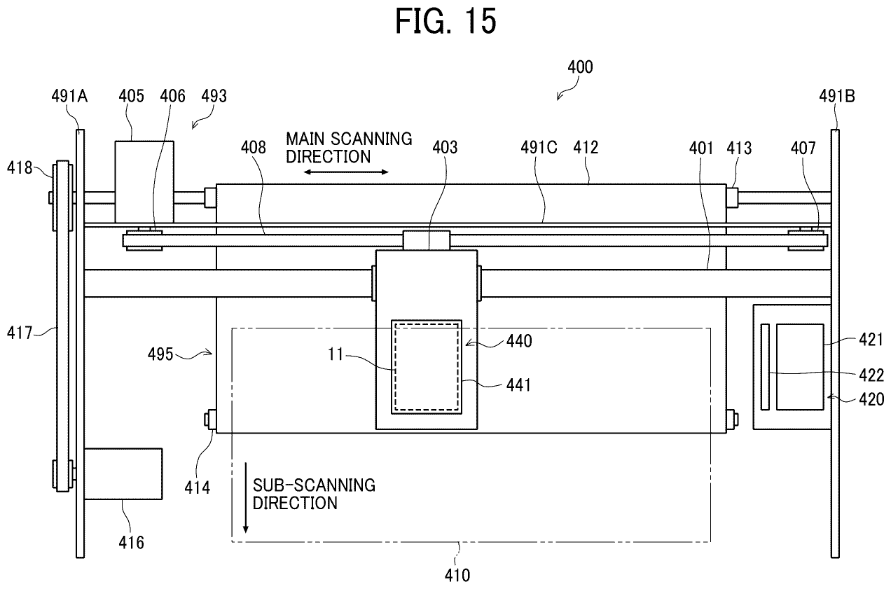

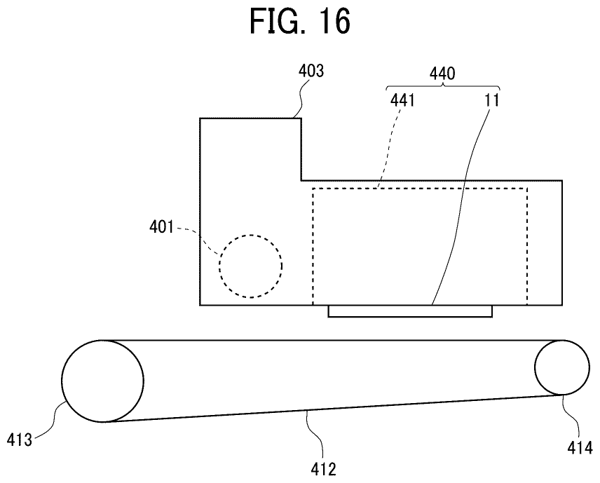

Another printer 400 as a liquid discharge apparatus is described below with reference to FIGS. 15 and 16. As the liquid discharge apparatus and an image forming apparatus, the printer 400 is a serial type printing apparatus, and a main-scanning moving mechanism 493 reciprocally moves a carriage 403 in the main scanning direction.

The main-scanning moving mechanism 493 includes a guide 401, a main scanning motor 405, and a timing belt 408. The guide 401 is bridged between left and right side plates 491A and 491B to movably hold the carriage 403. The carriage 403 is reciprocally moved in the main scanning direction by driving force of the main scanning motor 405 transmitted via the timing belt 408 looped around a drive pulley 406 and a driven pulley 407.

The carriage 403 mounts a liquid discharge unit 440 including the liquid discharge head 11 and a head tank 441 as a single integrated unit. The liquid discharge head 11 discharges color liquids of, for example, yellow (Y), cyan (C), magenta (M), and black (K). The liquid discharge head 11 is mounted on the liquid discharge unit 440 such that a nozzle row including the multiple nozzles is arranged in the sub-scanning direction perpendicular to the main scanning direction. The liquid discharge head 11 discharges the color liquid downward from the multiple nozzles. The liquid discharge head 11 is coupled to a liquid circulation device so that a liquid of a desired color is circulated and supplied to the liquid discharge head 11.

The printer 400 includes a conveyance mechanism 495 to convey a sheet 410 as the recording medium. The conveyance mechanism 495 includes a conveyance belt 412 as a conveyor and a sub-scanning motor 416 to drive the conveyance belt 412. The conveyance belt 412, which is an endless belt, is stretched between a conveyance roller 413 and a tension roller 414, and conveys the sheet 410 at a position facing the liquid discharge head 11 while attracting the sheet 410. The sheet 410 can be attracted to the conveyance belt 412 by, for example, electrostatic attraction or air suction. The conveyance belt 412 is circumferentially moved in the sub-scanning direction by driving force of the sub-scanning motor 416 transmitted via a timing belt 417 and a timing pulley 418.

On one end of the range of movement of the carriage 403 in the main scanning direction, a maintenance mechanism 420 that maintains and recovers the liquid discharge head 11 is disposed lateral to the conveyance belt 412. The maintenance mechanism 420 includes, for example, a cap 421 to cap a nozzle face (i.e., a face on which the multiple nozzles are formed) of the liquid discharge head 11 and a wiper 422 to wipe the nozzle face. The main-scanning moving mechanism 493, the maintenance mechanism 420, and the conveyance mechanism 495 are mounted onto a housing including the side plates 491A and 491B and a back plate 491C.

In the printer 400 having the above-described configuration, the sheet 410 is attracted on the conveyance belt 412 and conveyed in the sub-scanning direction by the circumferential movement of the conveyance belt 412. The liquid discharge head 11 is driven in response to an image signal while the carriage 403 moves in the main scanning direction to discharge a liquid onto the sheet 410 not in motion. As a result, an image is formed on the sheet 410.

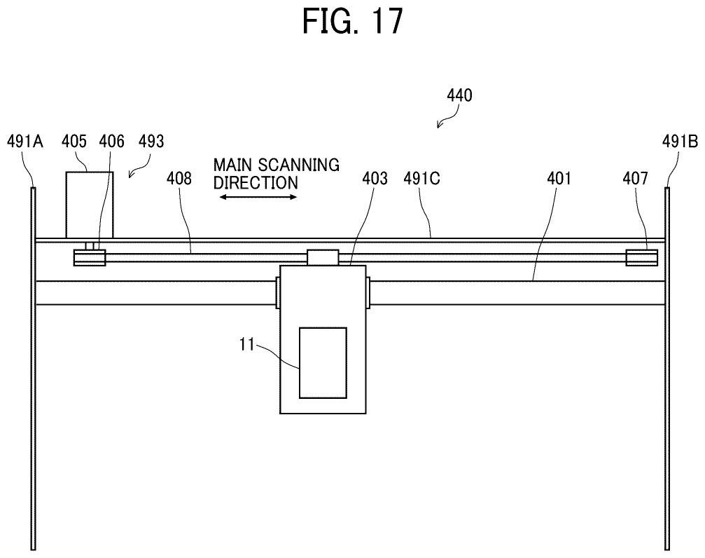

The above-described liquid discharge unit 440 is described below with reference to FIG. 17. The liquid discharge unit 440 includes the housing, the main-scanning moving mechanism 493, the carriage 403, and the liquid discharge head 11 among components of the printer 400 as the liquid discharge apparatus and the image forming apparatus. The side plates 491A and 491B, and the back plate 491C construct the housing. In the liquid discharge unit 440, the maintenance mechanism 420 described above may be mounted on, for example, the side plate 491B.

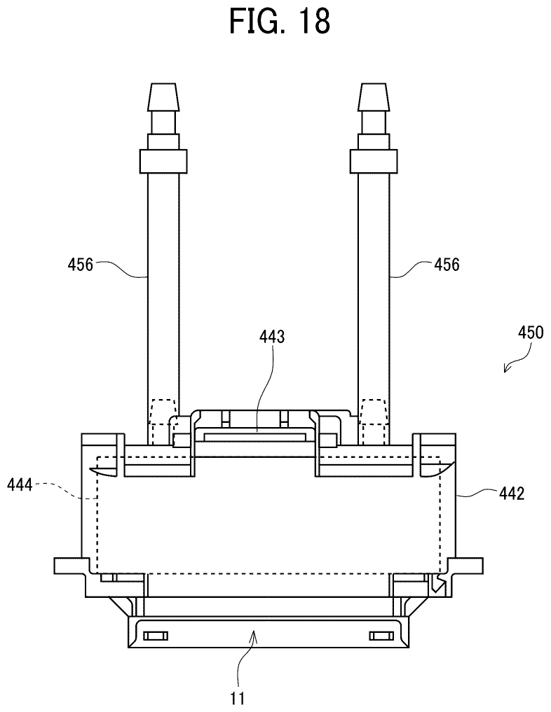

Another liquid discharge unit 450 is described below with reference to FIG. 18. The liquid discharge unit 450 illustrated in FIG. 18 includes the liquid discharge head 11 to which a channel component 444 is attached, and a tube 456 connected to the channel component 444. The channel component 444 is disposed inside a cover 442, and a connector 443 for electrically connecting to the liquid discharge head 11 is disposed on an upper portion of the channel component 444. In some embodiments, the liquid discharge unit 440 may include the head tank 441 instead of the channel component 444.

Each of the liquid discharge units 10, 10A, 10B, 440, 450, and 550 and each of the printers 400 and 500 as the liquid discharge apparatus, which includes the liquid discharge head 11 described above, can attain the same operational effects as the operational effects of the liquid discharge head 11 described above.

In the present disclosure, the liquid to be used is not limited to a particular liquid as long as the liquid has a viscosity or surface tension to be discharged from a head (liquid discharge head). However, preferably, the viscosity of the liquid is not greater than 30 millipascal-second (mPa·s) under ordinary temperature and ordinary pressure or by heating or cooling. Examples of the liquid include a solution, a suspension, or an emulsion that contains, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; or an edible material, such as a natural colorant. Such a solution, a suspension, or an emulsion can be used for, e.g., inkjet ink, surface treatment solution, or a material solution for three-dimensional fabrication.

Examples of an energy source for generating energy to discharge liquid include a piezoelectric actuator (a laminated piezoelectric element or a thin-film piezoelectric element), a thermal actuator that employs a thermoelectric transducer, such as a thermal resistor, and an electrostatic actuator including a diaphragm and opposed electrodes.

The pressure generator used in the liquid discharge head is not limited to a particular type of pressure generator. In addition to the above-described piezoelectric actuator (which may use a laminated piezoelectric element), for example, a thermal actuator using a thermoelectric transducer such as a thermal resistor, and an electrostatic actuator including a diaphragm and opposed electrodes can be used.

The “liquid discharge unit” is an assembly of parts relating to liquid discharge. The term “liquid discharge unit” represents a structure including the liquid discharge head and a functional component(s) or mechanism(s) combined with the liquid discharge head as a single unit. For example, the “liquid discharge unit” includes a combination of the liquid discharge head with at least one of a head tank, a carriage, a supply mechanism, a maintenance mechanism, a main-scanning moving mechanism, or a liquid circulation device.

The above integration may be achieved by, for example, a combination in which the liquid discharge head and a functional part(s) are secured to each other through, e.g., fastening, bonding, or engaging, and a combination in which one of the liquid discharge head and a functional part(s) is movably held by another. The liquid discharge head may be detachably attached to the functional part(s) or mechanism(s) each other.

The liquid discharge head and the head tank may be assembled, or the liquid discharge head and the head tank may be coupled (connected) to each other via, for example, a tube to form the liquid discharge unit as a single unit. A unit including a filter may further be added to a portion between the head tank and the liquid discharge head of the liquid discharge unit.

The liquid discharge unit may be an integrated unit in which the liquid discharge head and the carriage are integrated as a single unit, or the liquid discharge head, the carriage, and the main-scanning moving mechanism are integrated as a single unit. As yet another example, the liquid discharge unit is a unit in which the liquid discharge head and the scanning moving mechanism are combined into a single unit. The liquid discharge head is movably held by a guide that is a part of the scanning moving mechanism.

In another example, the cap that forms a part of the maintenance mechanism is fixed to the carriage mounting the liquid discharge head so that the liquid discharge head, the carriage, and the maintenance mechanism are integrated as a single unit to form the liquid discharge unit. Further, in another example, the liquid discharge unit includes a tube connected to the liquid discharge head mounting the head tank or the channel component so that the liquid discharge head and the supply mechanism are integrated as a single unit. Through the tube, the liquid in a liquid storage source is supplied to the liquid discharge head.

The main-scanning moving mechanism may be a guide only. The supply mechanism may be a tube(s) only or a loading unit only.

Although the liquid discharge unit includes the liquid discharge head as described above, examples of the liquid discharge unit include a head module and the head unit including the above-described liquid discharge head, with which the above-described functional components or mechanisms are combined to form a single unit.

The liquid discharge apparatus used herein also represents a liquid discharge apparatus including the liquid discharge head, the liquid discharge unit, the head module, or the head unit to drive the liquid discharge head to discharge liquid. The liquid discharge apparatus used herein includes, in addition to apparatuses to discharge liquid to a medium onto which liquid can adhere, apparatuses to discharge the liquid into gas (air) or a different liquid.

The liquid discharge apparatus may further include devices relating to feeding, conveying, and ejecting of the medium onto which liquid can adhere and also include a pretreatment device and an aftertreatment device.

The liquid discharge apparatus may be, for example, an image forming apparatus to form an image on a recording medium by discharging ink, or a three-dimensional fabrication apparatus to discharge fabrication liquid to a powder layer in which powder material is formed in layers to form a three-dimensional object.

The liquid discharge apparatus is not limited to an apparatus that discharges liquid to visualize meaningful images such as letters or figures. For example, the liquid discharge apparatus may be an apparatus that forms patterns having no meaning or an apparatus that fabricates three-dimensional images.

The medium onto which liquid can adhere described above represents a medium onto which liquid is at least temporarily adhered, a medium onto which liquid is adhered and fixed, or a medium into which liquid adheres and permeates. Examples of the medium onto which liquid can adhere include recording medium, such as paper sheet, recording paper, recording sheet of paper, film, and cloth, electronic components, such as electronic substrate and piezoelectric element, and media, such as powder layer, organ model, and testing cell. The medium onto which liquid can adhere includes any medium to which liquid adheres, unless otherwise specified.

Examples of the material for the medium onto which liquid can adhere include any materials to which liquid can adhere even temporarily, such as paper, thread, fiber, fabric, leather, metal, plastic, glass, wood, and ceramic.

The liquid discharge apparatus moves the liquid discharge head and the medium onto which liquid can adhere relative to each other. Which of the liquid discharge head or the medium onto which liquid can adhere is moved is not limited. For example, the liquid discharge apparatus may be a serial head apparatus that moves the liquid discharge head or a line head apparatus that does not move the liquid discharge head.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particles of the raw material.

The liquid discharge apparatus may also include an apparatus for manufacturing an electrode and an electrochemical element, which is also referred to as an electrode manufacturing apparatus. The electrode manufacturing apparatus is described below.

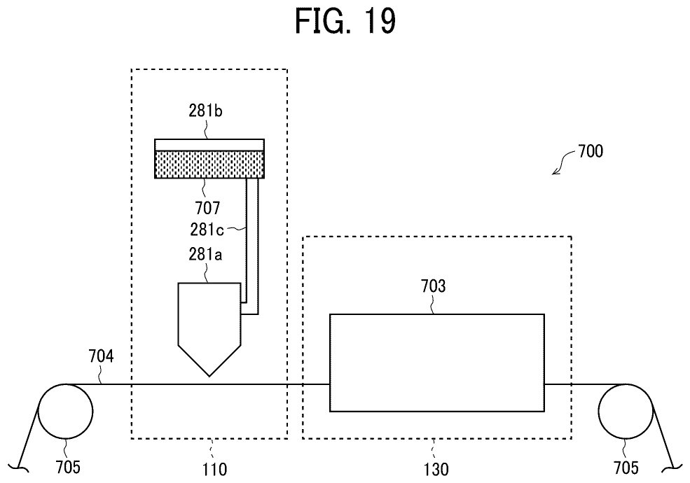

FIG. 19 is a schematic view of an electrode manufacturing apparatus. An electrode manufacturing apparatus 700 is an apparatus for manufacturing an electrode including a layer containing an electrode material by discharging a liquid composition using a liquid discharge unit including a liquid discharge head. A description is given below of a device and process for forming a layer containing an electrode material.

The liquid discharge device in the electrode manufacturing apparatus 700 illustrated in FIG. 19 is the liquid discharge unit described above. The liquid discharge head of the liquid discharge unit discharges a liquid composition. By so doing, the liquid composition is applied onto an object, and a liquid composition layer is formed on the object. The object, which may also be referred to as a discharge target in the following description, is not limited to any particular object and may be appropriately selected depending on the intended purpose, as long as the object is an object on which a layer containing an electrode material is to be formed. Examples of the object include an electrode substrate, i.e., a current collector, an active material layer, and a layer containing a solid electrode material. The object may be an electrode composite layer containing an active material on an electrode substrate. A discharge device (e.g., a discharge process device 110) and a discharge process may be a device and a process of forming a layer containing an electrode material by directly discharging a liquid composition as long as the layer containing an electrode material can be formed on a discharge target. The discharge device and the discharge process may be a device and a process of forming a layer containing an electrode material by indirectly discharging a liquid composition.

Other configurations and processes are described below. Other configurations included in the electrode manufacturing apparatus for manufacturing an electrode composite layer are not limited to any particular configuration and may be appropriately selected depending on the intended purpose, as long as the effects of the present embodiment are not impaired. Other processes included in the method for manufacturing an electrode composite layer are not limited to any particular process and may be appropriately selected depending on the intended purpose, as long as the effects of the present embodiment are not impaired. For example, a heating device and a heating process are examples of the configuration and the process included in the electrode manufacturing apparatus and the manufacturing method of the electrode composite layer.

The heating device and the heating process are described below. The heating device (e.g., a heating process device 130) included the electrode manufacturing apparatus for manufacturing an electrode composite layer is a device that heats the liquid composition discharged by the discharge device. The heating process included in the manufacturing method for manufacturing an electrode composite layer is a process of heating the liquid composition discharged in the discharge process. The liquid composition is heated to dry the liquid composition layer.

A description is given below of a structure to form a layer containing an electrode material by directly discharging a liquid composition. An electrode manufacturing apparatus, which forms a layer containing an electrode material, is described below. The electrode manufacturing apparatus forms an electrode composite layer containing an active material on an electrode substrate (current collector). As illustrated in FIG. 19, the electrode manufacturing apparatus 700 includes the discharge process device 110 and the heating process device 130. The discharge process device 110 performs a discharge process of applying a liquid composition onto a print base material 704 having a discharge target to form a liquid composition layer. The heating process device 130 performs a heating process of heating the liquid composition to obtain an electrode composite layer.

The electrode manufacturing apparatus 700 further includes a conveyance unit 705 that conveys the print base material 704. The conveyance unit 705 conveys the print base material 704 to the discharge process device 110 and the heating process device 130 in this order at a preset speed. A method of producing the print base material 704 having the discharge target such as an active material layer is not limited to any particular method, and a known method can be appropriately selected. The discharge process device 110 includes a liquid discharge head 281a that performs an application process of applying the liquid composition onto the print base material 704, a storage container 281b that stores a liquid composition 707, and a supply tube 281c that supplies the liquid composition 707 in the storage container 281b to the liquid discharge head 281a.

The discharge process device 110 discharges the liquid composition 707 from the liquid discharge head 281a so that the liquid composition 707 is applied onto the print base material 704 to form a liquid composition layer in a thin film shape. The storage container 281b may be integrated with the electrode manufacturing apparatus that forms the electrode composite layer or may be detachable from the electrode manufacturing apparatus. The storage container 281b may be a container additionally attachable to a container integrated with the electrode manufacturing apparatus for manufacturing the electrode composite layer or to a container detachable from the electrode manufacturing apparatus for manufacturing the electrode composite layer. The storage container 281b that stably stores the liquid composition 707 and the supply tube 281c that stably supplies the liquid composition 707 can be used.

The heating process device 130 performs a solvent removal process of heating and removing the solvent remaining in the liquid composition layer. Specifically, the solvent that remains in the liquid composition layer is heated and dried by a heater 703 of the heating process device 130 to remove the solvent from the liquid composition layer. Accordingly, the electrode composite layer is formed. The heating process device 130 may perform the solvent removal process under reduced pressure.

The heater 703 is not limited to any particular heater and may be appropriately selected depending on the intended purpose. For example, the heater 703 may be a substrate heater, an infrared (IR) heater, or a hot air heater. The heater 703 may be a combination of at least two of the substrate heater, the IR heater, and the hot air heater. A heating temperature and heating time can be appropriately selected according to the boiling point of the solvent contained in the liquid composition 707 or the thickness of a formed film.

In the electrode manufacturing apparatus 700, a liquid discharge head similar to the liquid discharge head 11 described above is used as the liquid discharge head 281a.

The electrode manufacturing apparatus 700 is used to discharge the liquid composition to a desired position on the discharge target. The electrode composite layer can be suitably used, for example, as a part of the configuration of an electrochemical element. The configuration of the electrochemical element other than the electrode composite layer is not limited to any particular configuration, and a known configuration can be appropriately selected. Examples of the configuration other than the electrode composite layer include a positive electrode, a negative electrode, and a separator.

Aspects of the present disclosure are, for example, as follows.

### Aspect 1

An actuator unit includes a nozzle area having multiple rows in which multiple nozzles are arrayed at equal intervals in parallel to a sub-scanning direction, and multiple columns in which the multiple nozzles are arrayed at equal intervals at a predetermined angle with respect to a main scanning direction. In a first row which is any row among the multiple rows and a second row which is positioned immediately below the first row, an end portion shape is determined such that a nozzle positioned at an end of the second row is positioned on a downstream side in the sub-scanning direction from a nozzle second from the end of the first row.

In other words, an actuator unit includes a nozzle plate having: a first row having multiple nozzles arrayed at a first interval in a first direction; and a second row adjacent to the first row in an inclined direction inclined with respect to a second direction orthogonal to the first direction. The second row has the multiple nozzles arrayed at the first interval in the first direction. The first row and the second row are separated at a second interval in the second direction. The first row of the multiple nozzles has: a first nozzle at one end of the first row in the first direction; and a second nozzle adjacent to and inward from the first nozzle in the first direction. The second row of the multiple nozzles has: a third nozzle at one end of the second row in the first direction, and the third nozzle is positioned inward from the second nozzle in the first direction.

Further, the nozzle plate has a trapezoidal shape having a shorter base extending in the first direction, a longer base parallel to the shorter base and longer than the shorter base, and legs connecting the shorter base and the longer base. The first row and the second row are arranged in the second direction from the longer base toward the shorter base, and the first nozzle and the third nozzle are arrayed along one of the legs.

### Aspect 2

In the actuator unit according to Aspect 1, the end portion shape is determined so that the nozzle at the end of the second row is positioned on the downstream side in the sub-scanning direction from a nozzle third from the end of the first row.

In other words, the first row of the multiple nozzles has a fourth nozzle adjacent to and inward from the second nozzle in the first direction, and the third nozzle is positioned inward from the fourth nozzle in the first direction.

### Aspect 3

A liquid discharge head includes multiple actuator units according to Aspect 1 or 2.The multiple actuator units are coupled to each other.

In other words, a liquid discharge head includes multiple actuator units including the actuator unit according to Aspect 1 or 2. The multiple actuator units are coupled to each other in the first direction.

### Aspect 4

In the liquid discharge head according to Aspect 3, one of the actuator units and another of the actuator units coupled to each other have an overlapping portion in which the nozzles are overlapped with each other in the main scanning direction in a part of the multiple columns formed when the actuator units are coupled to each other.

In other words, the multiple actuator units include: a first actuator unit having a fourth nozzle in a first overlapping portion; and a second actuator unit coupled to the first actuator unit. The second actuator unit has a fifth nozzle in a second overlapping portion overlapped with the first overlapping portion, and the fourth nozzle in the first overlapping portion is disposed at a same position with the fifth nozzle in the second overlapping portion in the first direction.

### Aspect 5

In the liquid discharge head according to Aspect 3 or 4, each of the multiple actuator units has a trapezoidal shape.

### Aspect 6

In the liquid discharge head according to any one of Aspects 3 to 5, each of the multiple actuator units is bilaterally symmetrical.

In other words, each of the multiple actuator units is bilaterally symmetrical in the first direction.

### Aspect 7

In the liquid discharge head according to Aspect 6, the multiple actuator units are formed such that the nozzle at the end of the second row is positioned at an intermediate position between the nozzle second from the end of the first row and a nozzle third from the end of the first row.

In other words, the first row of the multiple nozzles has a fourth nozzle adjacent to and inward from the second nozzle in the first direction, and the third nozzle is positioned between the second nozzle and the fourth nozzle in the first direction in each of the multiple actuator units.

### Aspect 8

A liquid discharge unit includes the liquid discharge head according to any one of Aspects 3 to 7.

In other words, a liquid discharge unit includes the liquid discharge head according to any one of Aspects 3 to 7, to discharge a liquid and a carriage mounting the liquid discharge head to move the liquid discharge head in the second direction.

### Aspect 9

An image forming apparatus includes the liquid discharge head according to any one of Aspects 3 to 7.

In other words, an image forming apparatus includes the liquid discharge head according to any one of Aspects 3 to 7, to discharge a liquid onto a medium to form an image and a conveyor to convey the medium to the liquid discharge head in the second direction.

### Aspect 10

A liquid discharge apparatus includes the liquid discharge head according to any one of Aspects 3 to 7.

In other words, a liquid discharge apparatus includes the liquid discharge head according to any one of Aspects 3 to 7, to discharge a liquid onto a medium and a conveyor to convey the medium to the liquid discharge head in the second direction.

### Aspect 11

A liquid discharge apparatus includes the liquid discharge unit according to Aspect 8.

In other words, a liquid discharge apparatus includes the liquid discharge unit according to Aspect 8, to discharge the liquid onto a medium and a conveyor to convey the medium to the liquid discharge unit in the first direction.

### Aspect 12

A liquid discharge head further includes multiple actuator units including the actuator unit according to Aspect 2. The multiple actuator units include: a first actuator unit having the shorter base and the longer base; and a second actuator unit coupled to the first actuator unit in the first direction. The second actuator unit has the shorter base and the longer base arranged opposite to the shorter base and the longer base of the first actuator unit in the second direction.

According to one aspect of the present disclosure, an actuator unit can be provided that prevents the increase in size and prevents the discharge bending.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An actuator unit comprising:
a nozzle plate having:
a first row having multiple nozzles arrayed at a first interval in a first direction; and
a second row adjacent to the first row in an inclined direction inclined with respect to a second direction orthogonal to the first direction,
the second row having the multiple nozzles arrayed at the first interval in the first direction,
wherein the first row and the second row are separated at a second interval in the second direction,
the first row of the multiple nozzles has:
a first nozzle at one end of the first row in the first direction; and
a second nozzle adjacent to and inward from the first nozzle in the first direction,
the second row of the multiple nozzles has:
a third nozzle at one end of the second row in the first direction, and
the third nozzle is positioned inward from the second nozzle in the first direction.

2. The actuator unit according to claim 1,
wherein the nozzle plate has a trapezoidal shape having:
a shorter base extending in the first direction;
a longer base parallel to the shorter base and longer than the shorter base; and
legs connecting the shorter base and the longer base,
the first row and the second row are arranged in the second direction from the longer base toward the shorter base, and
the first nozzle and the third nozzle are arrayed along one of the legs.

3. The actuator unit according to claim 1,
wherein the first row of the multiple nozzles has:
a fourth nozzle adjacent to and inward from the second nozzle in the first direction, and
the third nozzle is positioned inward from the fourth nozzle in the first direction.

4. A liquid discharge head further comprising multiple actuator units including the actuator unit according to claim 1,
wherein the multiple actuator units are coupled to each other in the first direction.

5. The liquid discharge head according to claim 4,
wherein the multiple actuator units include:
a first actuator unit having a fourth nozzle in a first overlapping portion; and
a second actuator unit coupled to the first actuator unit, the second actuator unit having a fifth nozzle in a second overlapping portion overlapped with the first overlapping portion, and
the fourth nozzle in the first overlapping portion is disposed at a same position with the fifth nozzle in the second overlapping portion in the first direction.

6. The liquid discharge head according to claim 4, wherein each of the multiple actuator units has a trapezoidal shape.

7. The liquid discharge head according to claim 4,
wherein each of the multiple actuator units is bilaterally symmetrical in the first direction.

8. The liquid discharge head according to claim 7,
wherein the first row of the multiple nozzles has:
a fourth nozzle adjacent to and inward from the second nozzle in the first direction, and
the third nozzle is positioned between the second nozzle and the fourth nozzle in the first direction in each of the multiple actuator units.

9. A liquid discharge unit comprising:
the liquid discharge head according to claim 4, to discharge a liquid; and
a carriage mounting the liquid discharge head to move the liquid discharge head in the second direction.

10. An image forming apparatus comprising:
the liquid discharge head according to claim 4, to discharge a liquid onto a medium to form an image; and
a conveyor to convey the medium to the liquid discharge head in the second direction.

11. A liquid discharge apparatus comprising:
the liquid discharge head according to claim 4, to discharge a liquid onto a medium;
and a conveyor to convey the medium to the liquid discharge head in the second direction.

12. A liquid discharge apparatus comprising:
the liquid discharge unit according to claim 9, to discharge the liquid onto a medium;
and a conveyor to convey the medium to the liquid discharge unit in the first direction.

13. A liquid discharge head further comprising multiple actuator units including the actuator unit according to claim 2,
wherein the multiple actuator units include:
a first actuator unit having the shorter base and the longer base; and
a second actuator unit coupled to the first actuator unit in the first direction, and
the second actuator unit has the shorter base and the longer base arranged opposite to the shorter base and the longer base of the first actuator unit in the second direction.
